(19) United States
(12) Patent Application Publication
(10) Pub. No.: US 2022/0380214 A1
(43) Pub. Date: Dec. 1, 2022

(54) METHOD FOR PREPARING 3D CARBONITRIDE COATED VSE2 COMPOSITE (3D-VSe2@CN)

(71) Applicant: GUANGDONG UNIVERSITY OF TECHNOLOGY, Guangzhou (CN)

(72) Inventors: Miao HE, GUANGZHOU (CN); Chenhao XU, GUANGZHOU (CN); Yefeng FENG, GUANGZHOU (CN); Li CHEN, GUANGZHOU (CN); Deping XIONG, GUANGZHOU (CN)

(21) Appl. No.: 17/334,741

(22) Filed: May 30, 2021

(51) Int. Cl. C01B 21/082; H01M 10/36; H01M 4/58; H01M 4/36; C09D 1/00; C01B 19/00; C01G 31/02

(52) U.S. Cl. CPC C01B 21/0828; H01M 10/36; H01M 4/58; H01M 4/366; C09D 1/00; C01B 19/007; C01G 31/02; C01P 2004/04; C01P 2004/03; C01P 2002/01; C01P 2002/74

(57) ABSTRACT

The disclosure relates to a method for preparing a 3D sponge structured carbonitride coated VSe₂ composite (3D-VSe₂@CN), belonging to the technical fields of electrode materials and preparation of batteries. In the disclosure, carbon, nitrogen and VSe₂ are composited by using NaCl as a template so as to construct a 3D sponge structured carbonitride coated VSe₂ composite. The 3D sponge structure can increase the structure stability of the material in the cyclic process, and the carbocanitride can increase the electron conductivity and activity sites of the material, so as to allow easier diffusion of potassium ions. Meanwhile, the stable structure can cause the clustering of VSe₂ all the time. Thus, the prepared composite has good and stable rate capability and cycle stability. The process method is simple, low in cost, environmental-friendly, and suitable for large-scale industrial production.

### TECHNICAL FIELD

The disclosure mainly relates to the technical field of novel ion battery preparation, particularly to an anode material of a potassium ion battery, namely a 3D-VSe₂@CN composite which has a 3D sponge structure and is prepared by using carbonitride via a template and preparation application thereof.

### BACKGROUD OF THE PRESENT INVENTION

With the development of lithium batteries for decades, lithium ion batteries have been widely applied to the fields of digital consumer products, electric vehicles and energy storage. Compared with reserve volumes of sodium element (2.36 wt %) and potassium element (2.09%) on the earth, the lithium element has the reserve volume of about 0.0017 wt %, which has low reserve volume and unbalance distribution in nature and expensive price, significantly restricting the application of lithium batteries as large-scale energy storage and power batteries. Development of novel ion batteries is an inevitable trend in the field of battery energy storage. Because ion batteries have low cost, potassium ions can rapidly move in electrolyte and have high working voltage and other advantages, the potassium ion battery is a novel ion battery which is potential to replace the lithium ion battery. However, since the potassium ion has a large radius, it is huge challenge to develop a reversible electrode material with a large ion radius.

VSe₂ (vanadium diselenide), as a typical graphene-like transition metal selenide, is widely applied to researches on energy, electronic devices, photoelectricity and the like due to its unique graphene-like structure, excellent electric performance, mechanical performance and the like. As early as 1978, Dr. M. Stanley Whittingham had done application of a VSe₂ material in lithium ion batteries, and pointed out that compared with other transition metal selenide materials, the c/a value of VSe₂ is 1.82, the interlayer spacing is much larger than those of other TMD materials (6.1 Å), and therefore the VSe₂ material is an ideal potassium ion battery anode material. However, due to different preparation methods, generally, vanadium diselenide materials prepared by using a hydrothermal method or a solvothermal method are high in yield, but have many product impurities and poor crystal structure, which causes poor conductivity of VSe₂ per se; furthermore, re-stacking and other phenomena are easily generated, which leads to rapid decrease of its capacity in the process of battery circulation. To improve the phenomenon, an effective method to solve the problem is to prepare a carbon-nitrogen coated composite having a 3D structure with vanadium diselenide as a substrate, NaCl as a template, citric acid as a carbon source and melamine as a nitrogen source. This composite is applied to potassium ion batteries, which can greatly improve the electrochemical performances of the batteries.

### SUMMARY OF PRESENT INVENTION

In order to solve the above technical problem, the disclosure provides a method for preparing a3D sponge structured carbonitride coated VSe₂ composite (3D-VSe₂@CN) and a preparation method thereof. This method is simple to operate, rich and stable in structure layers and large in specific surface area, and is capable of effectively improving the rate capability of an anode material. Meanwhile, the 3D sponge structure can well inhibit the material volume expansion caused by potassium ion intercalation reaction and side reactions such as agglomeration in the charging and discharging processes of the battery, thereby improving the cycle performance of the material.

According to the 3D sponge structured carbonitride coated VSe₂ composite (3D-VSe₂@CN) and the preparation method of the disclosure, the 3D-VSe₂@CN composite is prepared by combination of the solvothermal method and the NaCl template method. In the composite, the mass percentage of vanadium diselenide is about 70%, and the mass of carbon and nitrogen accounts for about 30%. The preparation method specifically comprises the following steps:

1. weighing and dissolving vanadyl acetylacetonate (VO(acac)₂) and vanadium diselenide into an organic solvent to be prepared into a mixed solution, stirring for 30 min to obtain a black green solution;

2. taking a certain amount of organic acid to be dropwisely added into the mixed solution, and continuing to stir for 30 min to obtain a mixed solution;

3. transferring the mixed solution obtained in step 2 into a Teflon lining high-pressure reactor, and carrying out heat preservation for 20˜28 h at 180˜220° C.;

4. when cooling the solution obtained in step 3 to room temperature, filtering under the reduced pressure with deionized water and absolute ethyl alcohol, and repeatedly washing to obtain a black metal luster precipitate;

5. drying the black metal luster precipitate obtained in step 4 in an oven at 80° C. to obtain black powders;

6. taking a certain mass of citric acid and melamine to be prepared into a mixed solution with deionzied water;

7. blending the black powders and the mixed solution in step 5) and step 6), and stirring for 1˜2 h;

8. adding a certain mass of NaCl into the blended solution in step 7, and continuously stirring 18˜28 h;

9. drying the black mixed solution obtained in step 8 for 12˜24 h at 50˜100° C.; and

10. raising the temperature of the black powers obtained in step 9 to 180˜300° C. from 25° C. at 1˜5° C./min under the inert atmosphere, carrying out heat preservation for 1˜5 h; then raising the temperature to 450˜800° C. at 1˜5° C./min, and carrying out heat preservation for 2˜5 h; naturally cooling to room temperature to obtain the 3D carbonitride coated VSe₂ composite (3D-VSe₂@CN).

Introduction

In step 1, the vanadium oxide is vanadium disoxide; the selenium oxide is vanadium diselenide; the solvent is one of deionized water or N-methylpyrrolidone.

In step 2, the organic solvent is one of acetic acid or formic acid.

In step 3, the heat preservation temperature is preferably controlled at 180˜220° C., and the heat preservation time is preferably controlled to 20˜28 h.

In step 4, the obtained black precipitate is repeatedly subjected to suction filtration and washing with deionzied water and absolute ethyl alcohol three times respectively.

In step 5, the drying temperature is preferably controlled at 80˜100° C., and the stirring time is preferably controlled to 18˜24 h.

In step 6, the mixed solution is a 10˜20% citric acid/2˜8% melamine mixed aqueous solution, and the temperature is preferably controlled at about 25˜30° C.;

In step 7, the products obtained in step 5 and step 6 are blended and stirred, and the time is preferably controlled to about 1˜2 h.

In step 8, the mass of NaCl added into the blended solution in step 7 is preferably controlled to 5˜20 g, and the stirring time is preferably controlled to 18˜28 h.

In step 9, the drying temperature is preferably controlled at 50˜100° C., and the heat preservation time is preferably controlled to 12˜24 h.

In step 10, the inert atmosphere is one or more of nitrogen or argon, preferably argon, the temperature rising rate is preferably 5° C./min, the first heat preservation temperature is preferably 180˜300° C. , and the heat preservation time is preferably 1˜5 h; the second heat preservation temperature is preferably 450˜800° C., and the heat preservation is preferably 2˜5 h.

In summary, the 3D carbonitride coated VSe₂ composite is prepared by the above method, and is used as the potassium ion battery anode material, 3D carbon-fluorine-nitrogen compound coated VSe₂ composite (3D-VSe₂@CN).

The 3D carbonitride coated VSe₂ composite anode material (3D-VSe₂@CN) of the disclosure has excellent rate capability and cycle stability. The 3D sponge structure, the carbonitride and vanadium diselenide form a synergistic effect to effectively inhibit the agglomeration of vanadium diselenide and meanwhile increase the conductivity of electrons and the diffusion rate of lithium ions, thereby effectively improving the rate capability and cycle stability of the material.

### DESCRIPTION OF THE DRAWINGS

FIG. 1 is an XRD (X-ray powder diffraction) pattern obtained by XRD analysis of 3D carbonitride coated VSe₂ and pure VSe₂ prepared in example 1 according to the disclosure, wherein a represents an XRD pattern of a 3D carbonitride coated VSe₂ anode composite (3D-VSe₂@CN) prepared in example 1, and b represents an XRD pattern of a pure layered VSe₂ material prepared in example 1;

FIG. 2 is an SEM (scanning electron microscope) image of 3D carbonitride coated VSe₂ (3D-VSe₂@CN) prepared in example 1 according to the disclosure;

FIG. 3 is an SEM image of a pure layered VSe₂ material prepared in example 1 according to the disclosure;

FIG. 4 is a TEM (transmission electron microscope) image of 3D carbonitride coated VSe₂ (3D-VSe₂@CN) prepared in example 1 according to the disclosure;

FIG. 5 is a TEM image of a pure layered VSe₂ material prepared in example 1 according to the disclosure;

FIG. 6 is a charging and discharging cycle performance graph of button batteries respectively made of 3D carbonitride coated VSe₂ (3D-VSe₂@CN) prepared in example 1 and a pure layered VSe₂ material prepared in comparative example 1 under the current density of 100 mAg⁻¹;

FIG. 7 is a charging and discharging rate capability graph of button batteries respectively made of 3D carbonitride coated VSe₂ (3D-VSe₂@CN) prepared in example 1 and a pure layered VSe₂ material prepared in comparative example 1 under the current density of 100 mAg⁻¹;

FIG. 8 is a charging and discharging long-cycle performance graph of button batteries respectively made of 3D carbonitride coated VSe₂ (3D-VSe₂@CN) prepared in example 1 and a pure layered VSe₂ material prepared in comparative example 1 under the current density of 500 mAg⁻¹;

FIG. 9 is a charging and discharging cycle performance graph of a button battery made of 3D carbonitride coated VSe₂ (3D-VSe₂@CN) prepared in example 2 under the current density of 100 mAg⁻¹;

FIG. 10 is a charging and discharging cycle performance graph of a button battery made of 3D carbonitride coated VSe₂ (3D-VSe₂@CN) prepared in example 3 under the current density of 100 mAg⁻¹.

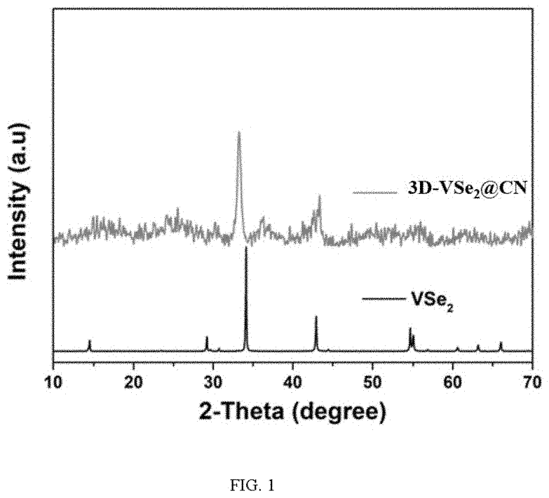

### DETAILED DESCRIPTION OF PREFERRED EMBODIMENTS

Next, the disclosure will be further described by taking a 3D carbonitride coated VSe₂ composite anode material (3D-VSe₂@CN) as a specific example. However, the disclosure is not limited to these examples.

### EXAMPLE 1

1. Vanadyl acetylacetonate (VO(acac)₂) and vanadium diselenide were weighed and dissolved into a N-methylpyrrolidone solvent to be prepared into a solution having a concentration of 1 mol/L, and the above solution was stirred for 0.5 h to obtain a black green solution;

2. formic acid was added into the salt solution obtained in step 1, and then continued to stir for 0.5 h to obtain a mixed solution;

3. the mixed solution obtained in step 2 was transferred into a Teflon lining high-pressure hydrothermal reactor and underwent heat preservation for 24 h at 220° C.;

4. when the solution obtained in step 3 was cooled to room temperature, the cooled solution was subjected to suction filtration and washing repeatedly with deionized water and absolute ethyl alcohol to obtain a black metal luster precipitate;

5. the black metal luster precipitate obtained in step 4 was dried for 24 h at 80° C. to obtain black powders;

6. the mixed solution was 10˜20% citric acid/2˜8% melamine mixed aqueous solution;

7. the black powders and the mixed solution in step 5 and step 6 were blended, and stirred for 1˜2 h;

8. a certain mass of NaCl was added into the blended solution in step 7, and continuously stirred for 18˜28 h;

9. the black mixed solution obtained in step 8 was dried for 12˜24 h at 50˜100° C. to obtain black powders; and

10. the black powers obtained in step 9 was heated to 180˜300° C. from 25° C. at 1˜5° C./min under the inert atmosphere and subjected to heat preservation of 1˜5 h, subsequently heated to 450˜800° C. at 1˜5° C./min and subjected to heat preservation of 2˜5 h, and naturally cooled to room temperature to obtain the 3D carbonitride coated VSe₂ composite anode material (3D-VSe₂@CN).

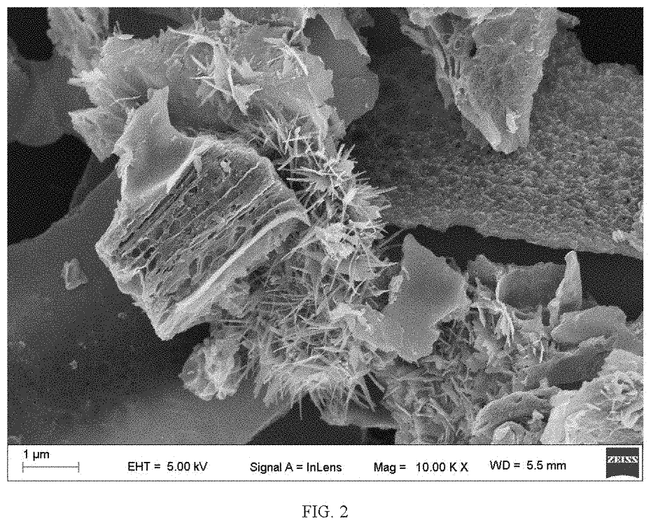

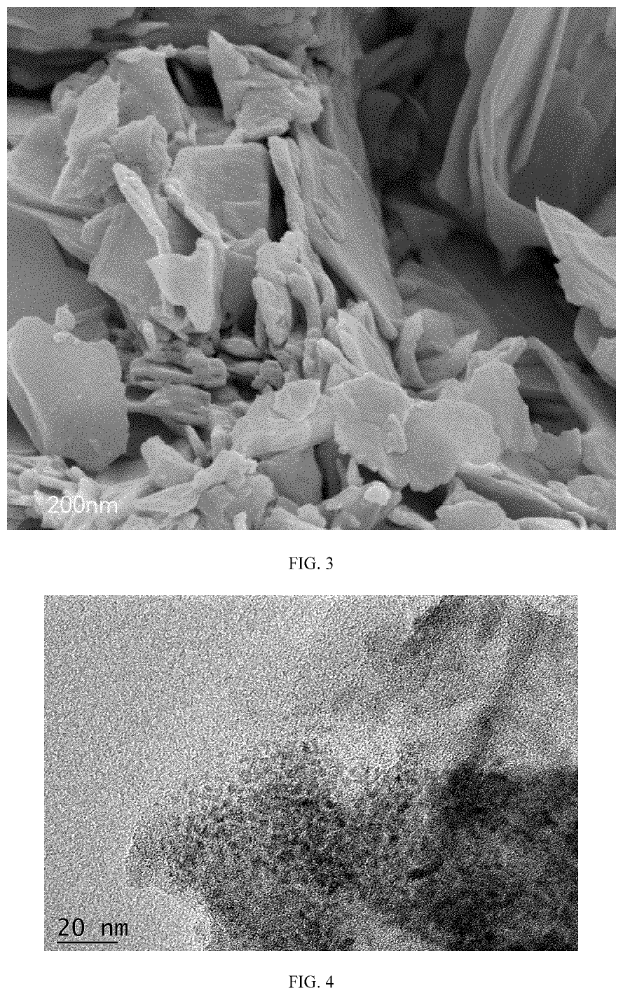

XRD analysis and SEM/TEM analysis were performed on the 3D carbonitride coated VSe₂ composite anode material (3D-VSe₂@CN) obtained in example 1 and the pure layered VSe₂ material obtained in example 1. It can be seen from XRD patterns that diffraction peaks of a carbon quantum dot/carbon coated VSe₂ composite and the layered VSe₂ material prior to modification are consistent, indicating that the 3D carbonitride coats the material phase structure of the VSe₂ composite anode material (3D-VSe₂@CN). The SEM image of the 3D carbonitride coated VSe₂ composite anode material (3D-VSe₂@CN) prepared in example 1 is shown in FIG. 2, and the SEM image of the pure layered VSe₂ material used in example 1 is shown in FIG. 3. By comparing FIG. 2 with FIG. 3, it can be seen that after 3D configuration treatment of vanadium diselenide, a series of changes on the microstructure of the material occur. Pore ducts become more abundant and the surface becomes rougher.

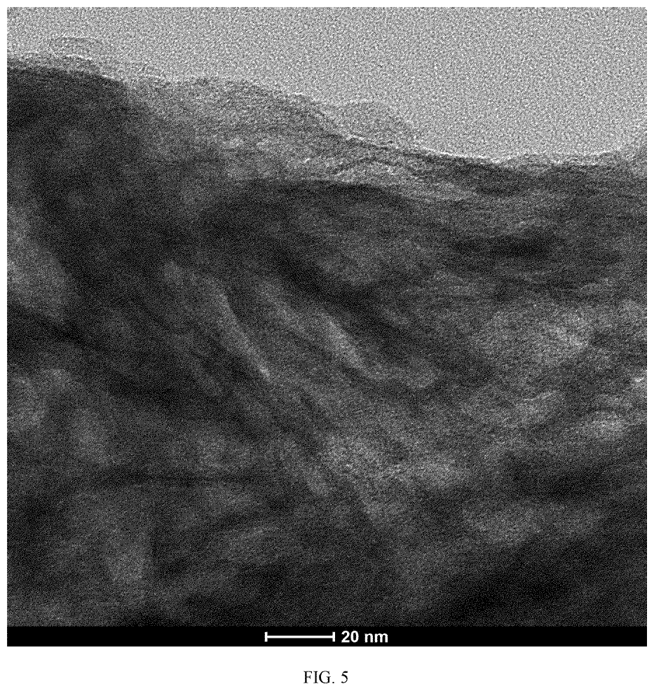

The TEM image of the 3D carbonitride coated VSe₂ composite anode material (3D-VSe₂@CN) prepared in example 1 is shown in FIG. 4, and the TEM image of the pure layered VSe₂ material used in example 1 is shown in FIG. 5. By comparing FIG. 4 with FIG. 5, it can be seen that after 3D configuration treatment, a large amount of 2˜5 nm carbonitrides are coated on the layered VSe₂ material, indicating that carbonitrides are successfully coated on the VSe₂ material.

The 3D carbonitride coated VSe₂ composite anode material (3D-VSe₂@CN) prepared in example 1, acetylene black and binder PVDF were dissolved into N-methylpyrrolidone in a ratio of 7.5:1.5:1.5 and stirred. The obtained slurry was applied to copper foil and dried in vacuum for 12 h to obtain a cathode pole. Then, battery assembly was performed in a glove box filled with argon, a cathode is the 3D carbonitride coated VSe₂ composite anode material (3D-VSe₂@CN), an anode is a potassium piece, a diaphragm is glass fiber, the electrolyte was 0.8M KPF₆ in EC:DEC (1:1). The electrochemical performance test is performed on the assembled button battery.

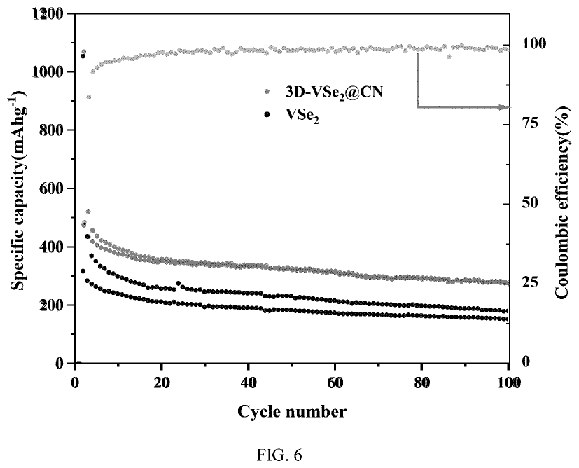

FIG. 6 is a charging and discharging cycle performance graph of button batteries respectively made of the 3D carbonitride coated VSe₂ composite anode material (3D-VSe₂@CN) in example 1 and the pure layered VSe₂ material prepared in comparative example 1 under the current density of 100 mAg⁻¹. It can be seen from FIG. 6 that the capacity of the 3D carbonitride coated VSe₂ composite anode material (3D-VSe₂@CN) in example 1 after 100 cycles is 298 mAhg⁻¹, however, the capacity of the pure layered VSe₂ material after 100 cycles is only 198 mAhg⁻¹. It can be seen from the above result that after the 3D carbonitride coated VSe₂ composite anode material (3D-VSe₂@CN) is adopted, the reversible capacity and cycle stability of the material can be effectively improved.

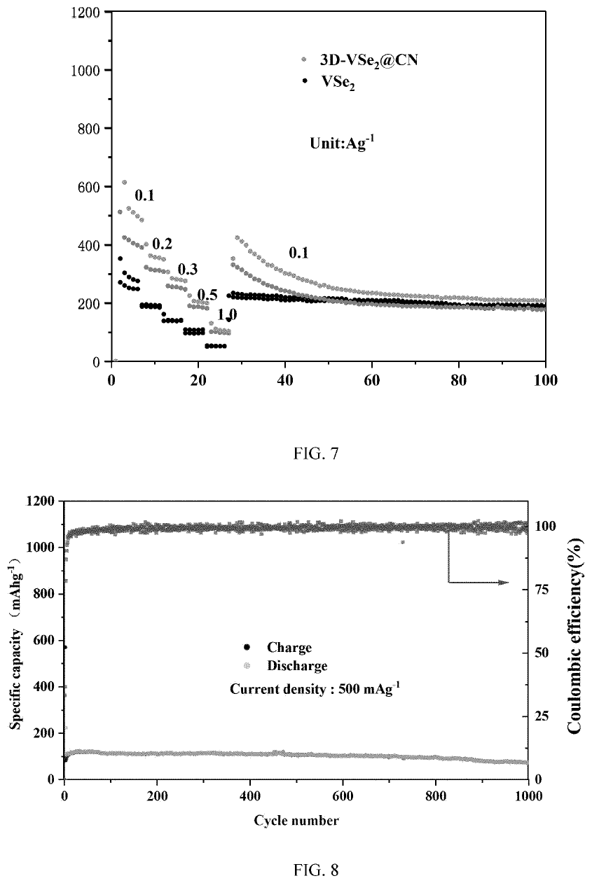

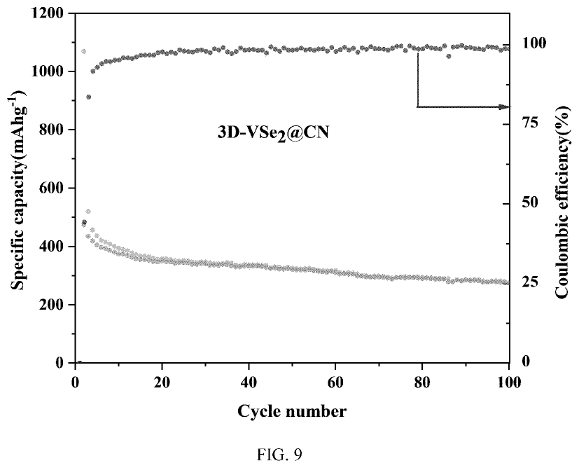

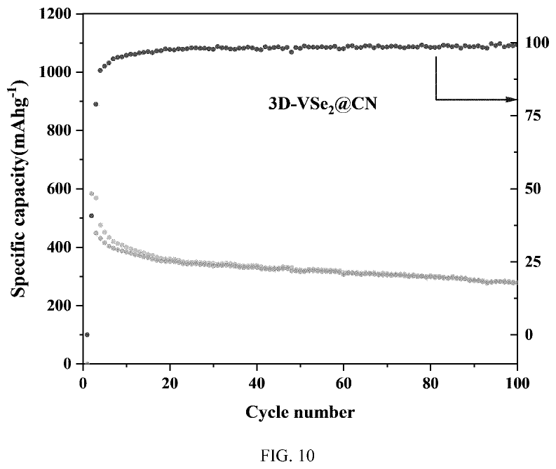

FIG. 7 is a charging and discharging rate capability graph of button batteries respectively made of 3D carbonitride coated VSe₂ (3D-VSe₂@CN) prepared in example 1 and a pure phase layered VSe₂ material prepared in comparative example 1 under the current density of 100˜1000 mAg⁻¹. It can be seen from FIG. 7 that the reversible capacities of the carbon quantum dot/carbon coated VSe₂ composite (VSe₂@CQD) prepared in example 1 under the current densities of 100, 200, 300, 500 and 1000 mAg⁻¹ are 501.2, 390.2, 290, 210 [symbol] 100.2 mAhg⁻¹. However, the capacities of the pure layered VSe₂ material under the same rate capability current densities are 300, 228.9, 190.2, 98.8 and 47.8 mAhg⁻¹. It can be seen from the above result that after the 3D carbonitride coated VSe₂ (3D-VSe₂@CN) is adopted, the capacity of the material under the large current density can be effectively improved.

FIG. 8 is a charging and discharging long-cycle performance graph of button batteries respectively made of 3D carbonitride coated VSe₂ (3D-VSe₂@CN) prepared in example 1 and a pure layered VSe₂ material prepared in comparative example 1 under the current density of 500 mAg⁻¹. It can be seen from FIG. 8 that the capacity of the 3D carbonitride coated VSe₂ composite (3D-VSe₂@CN) prepared in example 1 after 1000 cycles is maintained at 98.3 mAhg⁻¹. Consequently, after the 3D carbonitride coated VSe₂ composite anode material (3D-VSe₂@CN) is adopted, the long-cycle stability and structure stability of the material can be effectively improved.

### EXAMPLE 2

1. Vanadyl acetylacetonate (VO(acac)₂) and vanadium diselenide were weighed and dissolved into a N-methylpyrrolidone solvent to be prepared into a solution having a concentration of 1.5 mol/L, and the above solution was stirred for 0.5 h to obtain a black green solution;

2. formic acid was added into the salt solution obtained in step 1, and then further stirred for 0.5 h to obtain a mixed solution;

3. the mixed solution obtained in step 2 was transferred into a Teflon lining high-pressure hydrothermal reactor and underwent heat preservation for 24 h at 200° C.;

4. when the solution obtained in step 3 was cooled to room temperature, the cooled solution was subjected to suction filtration and washing repeatedly with deionized water and absolute ethyl alcohol to obtain a black metal luster precipitate;

5. the black metal luster precipitate obtained in step 4 was dried for 24 h at 80° C. to obtain black powders;

6. the mixed solution was 15% citric acid/3% melamine mixed aqueous solution;

7. the black powders and the mixed solution in step 5 and step 6 were blended, and stirred for 1˜2 h;

8. a certain mass of NaCl was added into the blended solution in step 7, and continuously stirred for 18˜28 h;

9. the black mixed solution obtained in step 8 was dried for 12˜24 h at 50˜100° C. to obtain black powders; and

10. the black powers obtained in step 9 was heated to 180˜300° C. from 25° C. at 1˜5° C./min under the inert atmosphere and subjected to heat preservation of 1˜5 h, subsequently heated to 450˜800° C. at 1˜5° C./min and subjected to heat preservation of 2˜5 h, and naturally cooled to room temperature to obtain the 3D carbonitride coated VSe₂ composite anode material (3D-VSe₂CN).

The 3D carbonitride coated VSe₂ composite anode material (3D-VSe₂@CN) prepared in example 2, acetylene black and binder PVDF were dissolved into N-methylpyrrolidone in a ratio of 7.5:1.5:1.5 and stirred. The obtained slurry was applied to copper foil and dried in vacuum for 12 h to obtain a cathode pole. Then, battery assembly was performed in a glove box filled with argon, a cathode is the 3D carbonitride coated VSe₂ composite anode material (3D-VSe₂@CN), an anode is a potassium piece, a diaphragm is glass fiber, and the electrolyte was 0.8M KPF₆. The electrochemical performance test was performed between 0.01 V and 3.0V at 25° C., and the result indicates that the 3D carbonitride coated VSe₂ composite anode material (3D-VSe₂@CN) prepared in example 2 has excellent rate capability and cycle stability.

### EXAMPLE 3

1. Vanadyl acetylacetonate (VO(acac)₂) and vanadium diselenide were weighed and dissolved into a N-methylpyrrolidone solvent to be prepared into a solution having a concentration of 1.2 mol/L, and the above solution was stirred for 0.5 h to obtain a black green solution;

2. formic acid was added into the salt solution obtained in step 1, then further stirred for 0.5 h to obtain a mixed solution;

3. the mixed solution obtained in step 2 was transferred into a Teflon lining high-pressure hydrothermal reactor to undergo heat preservation for 24 h at 200° C.;

4. when the solution obtained in step 3 was cooled to room temperature, the cooled solution was subjected to suction filtration and washing repeatedly with deionized water and absolute ethyl alcohol to obtain a black metal luster precipitate;

5. the black metal luster precipitate obtained in step 4 was dried for 24 h at 80° C. to obtain black powders;

6. the mixed solution was 15% citric acid/5% melamine mixed aqueous solution;

7. the black powders and the mixed solution in step 5 and step 6 were blended, and stirred for 1˜2 h;

8. a certain mass of NaCl was added into the blended solution in step 7, and continuously stirred for 18˜28 h;

9. the black mixed solution obtained in step 8 was dried for 12˜24 h at 50˜100° C. to obtain black powders; and

10. the black powers obtained in step 9 was heated to 180˜300° C. from 25° C. at 1˜5° C./min under the inert atmosphere and subjected to heat preservation of 1˜5 h, subsequently heated to 450˜800° C. at 1˜5° C./min and heat preservation of 2˜5 h, and naturally cooled to room temperature to obtain the 3D carbonitride coated VSe₂ composite anode material (3D-VSe₂@CN).

The 3D carbonitride coated VSe₂ composite anode material (3D-VSe₂@CN) prepared in example 3, acetylene black and binder PVDF were dissolved into N-methylpyrrolidone in a ratio of 7.5:1.5:1.5 and stirred. The obtained slurry was applied to copper foil and dried in vacuum for 12 h to obtain a cathode pole. Then, battery assembly was performed in a glove box filled with argon, a cathode is the 3D carbonitride coated VSe₂ composite anode material (3D-VSe₂@CN), an anode is a potassium piece, a diaphragm is glass fiber, and the electrolyte was 0.8M KPF₆. The electrochemical performance test was performed between 0.01 V and 3.0V at 25° C., and the result indicates that the 3D carbonitride coated VSe₂ composite anode material (3D-VSe₂@CN) prepared in example 3 has excellent rate capability and cycle stability.

### EXAMPLE 4

1. Vanadyl acetylacetonate (VO(acac)₂) and vanadium diselenide were weighed and dissolved into a N-methylpyrrolidone solvent to be prepared into a solution having a concentration of 1 mol/L, and the above solution was stirred for 0.5 h to obtain a black green solution;

2. formic acid was added into the salt solution obtained in step 1, and then further stirred for 0.5 h to obtain a mixed solution;

3. the mixed solution obtained in step 2 was transferred into a Teflon lining high-pressure hydrothermal reactor to undergo heat preservation for 24 h at 180° C.;

4. when the solution obtained in step 3 was cooled to room temperature, the cooled solution was subjected to suction filtration and washing repeatedly with deionized water and absolute ethyl alcohol to obtain a black metal luster precipitate;

5. the black metal luster precipitate obtained in step 4 was dried for 24 h at 80° C. to obtain black powders;

6. the mixed solution was 20% citric acid/5% melamine mixed aqueous solution;

7. the black powders and the mixed solution in step 5 and step 6 were blended, and stirred for 1˜2 h;

8. a certain mass of NaCl was added into the blended solution in step 7, and continuously stirred for 18˜28 h;

9. the black mixed solution obtained in step 8 was dried for 12˜24 h at 50˜100° C. to obtain black powders; and

10. the black powers obtained in step 9 was heated to 180˜300° C. from 25° C. at 1˜5° C./min under the inert atmosphere and subjected to heat preservation of 1˜5 h, subsequently heated to 450˜800° C. at 1˜5° C./min and subjected to heat preservation of 2˜5 h, and naturally cooled to room temperature to obtain the 3D carbonitride coated VSe₂ composite anode material (3D-VSe₂@CN).

The 3D carbonitride coated VSe₂ composite anode material (3D-VSe₂@CN) prepared in example 4, acetylene black and binder PVDF were dissolved into N-methylpyrrolidone in a ratio of 7.5:1.5:1.5 and stirred. The obtained slurry was applied to copper foil and dried in vacuum for 12 h to obtain a cathode pole. Then, battery assembly was performed in a glove box filled with argon, a cathode is the 3D carbonitride coated VSe₂ composite anode material (3D-VSe₂@CN), an anode is a potassium piece, a diaphragm is glass fiber, and the electrolyte was 0.8M KPF₆. The electrochemical performance test was performed between 0.01 V and 3.0V at 25° C. , and the result indicates that the 3D carbonitride coated VSe₂ composite anode material (3D-VSe₂@CN) prepared in example 4 has excellent rate capability and cycle stability.

### EXAMPLE 5

1. Vanadyl acetylacetonate (VO(acac)₂) and vanadium diselenide were weighed and dissolved into a N-methylpyrrolidone solvent to be prepared into a solution having a concentration of 1 mol/L, and the above solution was stirred for 0.5 h to obtain a black green solution;

2. formic acid was added into the salt solution obtained in step 1, and then continued to stir for 0.5 h to obtain a mixed solution;

3. the mixed solution obtained in step 2 was transferred into a Teflon lining high-pressure hydrothermal reactor to undergo heat preservation for 24 h at 200° C.;

4. when the solution obtained in step 3 was cooled to room temperature, the cooled solution was subjected to suction filtration and washing repeatedly with deionized water and absolute ethyl alcohol to obtain a black metal luster precipitate;

5. the black metal luster precipitate obtained in step 4 was dried for 24 h at 80° C. to obtain black powders;

6. the mixed solution was 10˜20% citric acid/2˜8% melamine mixed aqueous solution;

7. the black powders and the mixed solution in step 5 and step 6 were blended, and stirred for 1˜2 h;

8. a certain mass of NaCl was added into the blended solution in step 7, and continuously stirred for 18˜28 h;

9. the black mixed solution obtained in step 8 was dried for 12˜24 h at 50˜100° C. to obtain black powders; and

10. the black powers obtained in step 9 was heated to 180˜300° C. from 25° C. at 1˜5° C./min under the inert atmosphere and subjected to heat preservation of 1˜5 h, subsequently heated to 450˜800° C. at 1˜5° C./min and subjected to heat preservation of 2˜5 h, and naturally cooled to room temperature to obtain the 3D carbonitride coated VSe₂ composite anode material (3D-VSe₂CN).

The 3D carbonitride coated VSe₂ composite anode material (3D-VSe₂@CN) prepared in example 5, acetylene black and binder PVDF were dissolved into N-methylpyrrolidone in a ratio of 7.5:1.5:1.5 and stirred. The obtained slurry was applied to copper foil and dried in vacuum for 12 h to obtain a cathode pole. Then, battery assembly was performed in a glove box filled with argon, a cathode is the 3D carbonitride coated VSe₂ composite anode material (3D-VSe₂@CN), an anode is a potassium piece, a diaphragm is glass fiber, the electrolyte was 0.8M KPF₆. The electrochemical performance test was performed between 0.01 V and 3.0V at 25° C. , and the result indicates that the 3D carbonitride coated VSe₂ composite anode material (3D-VSe₂@CN) prepared in example 5 has excellent rate capability and cycle stability.

We claim:

1. A method for preparing a 3D carbonitride coated VSe₂ composite (3D-VSe₂@CN), comprising the following steps:
1) a vanadium oxide and a selenium oxide are weighed and dissolved into water or an organic solvent to be prepared into a solution having a concentration of 0.5˜2 mol/L, and stirring for 0.5 h to obtain a black green solution;
2) an organic acid is added into the salt solution obtained in step 1), and stirring is continued for 0.5 h to obtain a mixed solution;
3) the mixed solution obtained in step 2) is transferred into a Teflon lining high-pressure hydrothermal reactor, and heat preservation is performed for 20˜28 h at 180˜220° C.;
4) after the solution obtained in step 3) is cooled, the cooled solution is subjected to suction filtration and washing with deionized water and absolute ethyl alcohol to obtain a black metallic luster precipitate;
5) the black precipitate obtained in step 4) is dried for 12˜24 h at 80˜100° C. to obtain black powders;
6) the mixed solution is a 10˜20% citric acid/2˜8% melamine mixed aqueous solution, and the temperature is preferably controlled at about 25˜30° C.;
7) the products in step 5) and step 6) are blended and stirred, and the preferred control time is about 1˜2 h;
8) the mass of NaCl added into the blended solution in step 7) is preferably controlled to 5˜20 g, and the stirring time is preferably controlled to 18˜28 h;
9) the drying temperature is preferably controlled at 50˜100° C., and the heat preservation time is preferably controlled to 12˜24 h; and
10) the inert atmosphere is nitrogen, the temperature rising rate is preferably 10˜5° C./min; the first heat preservation temperature is 180˜300° C., and the heat preservation time is 1˜5 h; the second heat preservation temperature is 450˜800° C., and the heat preservation time is 2˜5 h; the 3D carbonitride coated VSe₂ composite (3D-VSe₂@CN) is obtained after naturally cooling to room temperature.

2. The method for preparing a 3D carbonitride coated VSe₂ composite (3D-VSe₂@CN) according to claim 1, wherein in the 3D carbonitride coated VSe₂ composite (3D-VSe₂@CN), the mass percentage of VSe₂ is 70%, and the mass percentage of carbonitride is 30%.

3. The method for preparing a 3D carbonitride coated VSe₂ composite (3D-VSe₂@CN) according to claim 1, wherein in step 1), the vanadium oxide is vanadyl acetylacetonate (VO(acac)₂); the selenium oxide is selenium dioxide; the solvent is one of deionzied water and N-methylpyrrolidone;

4. The method for preparing a 3D carbonitride coated VSe₂ composite (3D-VSe₂@CN) according to claim 1, wherein the organic acid in step 2) is formic acid.

5. The method for preparing a 3D carbonitride coated VSe₂ composite (3D-VSe₂@CN) according to claim 1, wherein in step 3), the heat preservation temperature is preferably controlled at 180˜220° C., and the heat preservation time is preferably controlled to 20˜28 h.

6. The method for preparing a 3D carbonitride coated VSe₂ composite (3D-VSe₂@CN) according to claim 1, wherein in step 5), the drying temperature is preferably controlled at 80˜100° C. , and the heat preservation time is preferably controlled to 12˜24 h.

7. The method for preparing a 3D carbonitride coated VSe₂ composite (3D-VSe₂@CN) according to claim 1, wherein in step 6), the mixed solution is blended into 10˜20% citric acid (wt %)/2˜8% melamine mixed aqueous solution (wt %), and the temperature is preferably controlled at about 25˜30° C.

8. The method for preparing a 3D carbonitride coated VSe₂ composite (3D-VSe₂@CN) according to claim 1, wherein in step 7), the blending and stirring time is preferably controlled to about 1˜2 h.

9. The method for preparing a 3D carbonitride coated VSe₂ composite (3D-VSe₂@CN) according to claim 1, wherein in step 8), the mass of NaCl added into the blended solution is preferably controlled to 5˜20 g, and the stirring time is preferably controlled to 18˜28 h.

10. The method for preparing a 3D carbonitride coated VSe₂ composite (3D-VSe₂@CN) according to claim 1, wherein in step 9), the drying temperature is preferably controlled at 50˜100° C., and the heat preservation time is preferably controlled to 12˜24 h.

11. The method for preparing a 3D carbonitride coated VSe₂ composite (3D-VSe₂@CN) according to claim 1, wherein in step 10), the inert atmosphere is nitrogen; the temperature rising rate is preferably 10˜5° C./min; the first heat preservation temperature is preferably 180˜300° C., and the heat preservation time is preferably 1˜5 h; the second heat preservation temperature is preferably 450˜800° C., and the heat preservation time is preferably 2˜5 h; the 3D carbonitride coated VSe₂ composite (3D-VSe₂@CN) is obtained after naturally cooling to the room temperature.
